(19) United States
(12) Patent Application Publication
(10) Pub. No.: US 2026/0211476 A1
(43) Pub. Date: Jul. 23, 2026

(54) HIGH VOLTAGE WAKE SIGNALING INPUT/OUTPUT FOR 10BASE-T1S SYSTEM-BASIS-CHIP

(71) Applicant: Microchip Technology Incorporated, Chandler, AZ (US)

(72) Inventors: Lars Beilschmidt, Karlsruhe (DE); Venkatraman Iyer, Austin, TX (US); Kevin Yang, Shenzhen (CN); Elhossin Elshafey, Cork (IE); Peter E. Sheldon, Beaufort, SC (US)

(21) Appl. No.: 19/136,735

(22) PCT Filed: Jul. 16, 2024
(86) PCT No.: PCT/CN2024/105637

§ 371 Date: Jun. 6, 2025

Related U.S. Application Data
(63) Continuation of application No. PCT/CN2023/107647, filed on Jul. 17, 2023.

(51) Int. Cl. G06F 1/3206; G06F 1/28; G06F 1/3234

(52) U.S. Cl. CPC G06F 1/3206; G06F 1/28; G06F 1/3243

(57) ABSTRACT

A method may include receiving signaling at a system basis chip implementing a transceiver of a 10SPE PHY; changing, at the system basis chip, the signaling from first voltage levels incompatible with a voltage domain of a microcontroller (MCU) implementing a controller of the 10SPE PHY to second voltage levels compatible with the voltage domain of the MCU; and communicating the changed signaling to the MCU.

### CROSS-REFERENCE TO RELATED APPLICATIONS

This application is a national phase entry under 35 U.S.C. § 371 of International Patent Application PCT/CN2024/105637, filed Jul. 16, 2024, designating the United States of America and published as International Patent Publication WO 2025/016376 A1 on Jan. 23, 2025, which claims the benefit under Article 8 of the Patent Cooperation Treaty of Chinese Patent Application Serial No. PCT/CN2023/107647, filed Jul. 17, 2023.

### TECHNICAL FIELD

Examples relate, generally, to a 10SPE physical layers (PHY). Some examples relate, generally, to a system-basis-chip that implement a transceiver of a 10SPE PHY and a microcontroller that implements a controller of the 10SPE PHY. Some examples relate, generally, to such a system-basis-chip that handles high-voltage signaling to the PHY and interfaces the high-voltage signaling with the low-voltage domain of the microcontroller.

### BACKGROUND

A system basis chip (SBC) is an integrated circuit (IC) that combines multiple functions required for the operation of electronic systems. ICs and SBCs are utilized in a variety of operational context.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting a system that implements, among other things, a 10SPE PHY, in accordance with one or more examples.

FIG. 2 a circuit diagram depicting a high-voltage input/output for system-basis-chip (SBC), such as the SBC of FIG. 1, in accordance with one or more examples.

FIG. 3 is a schematic diagram of a system to drive a high-voltage GPIO of an SBC, in accordance with one or more examples.

FIG. 4 is a schematic diagram depicting system to generate an internal signal via a high-voltage IO of FIG. 2, in accordance with one or more examples.

FIG. 5 is a state diagram depicting behavior of an SBC managing a high voltage GPIO, in accordance with one or more examples.

FIG. 6 is a flow diagram depicting a process to handle high-voltage signals and interface them with a low-voltage MCU, in accordance with one or more example.

FIG. 7 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, steps, features, functions, or the like.

It will be readily understood that the components of the examples as generally described herein and illustrated in the drawing could be arranged and designed in a wide variety of different configurations. Thus, the following description of numerous examples is not intended to limit the scope of the present disclosure, but is merely representative of numerous examples. While the numerous aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application-Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation).

A system basis chip (SBC) is an integrated circuit (IC) that combines multiple functions for operation of an electronic system. An SBC typically integrates various, different functions into a single chip, including, as non-limiting examples: power management functions such as voltage regulators, power switches, or protection circuitry, without limitation, to manage the power supply for the system; communication interfaces such as CAN (Controller Area Network), LIN (Local Interconnect Network), SPI (Serial Peripheral Interface), or I2C (Inter-Integrated Circuit), without limitation; embedded systems such as state machines or microprocessors, without limitation, that control and coordinate tasks; analog functions such as analog-to-digital converters (ADCs), digital-to-analog converters (DACs), temperature sensors, and other signal conditioning circuitry; and diagnostic and safety functions, such as monitoring and reporting voltage levels, temperature, or fault conditions, without limitation.

SBCs are found in a variety of operational context, including automotive and industrial applications. A non-limiting example of an automotive application for SBC is in 10SPE (i.e., 10 Mbps Single Pair Ethernet) networks (also called “10BASE-T1S networks”). 10SPE is a network technology specified in IEEE 802.3 clause 147 and 148. 10SPE may be used to provide a collision free, deterministic transmission on a multi-drop network.

In some cases, a transceiver (xcvr) and controller of a 10SPE physical layer device (PHY) may be located on different die, as a non-limiting example, so the die undergo different processing conditions. Such an architecture is referred to herein as a “split-PHY” architecture. The digital blocks of the PHY controller, which are susceptible to damage during high voltage temperature processes are located on a first die that does not undergo high voltage temperature processes. Analog and digital blocks of the PHY transceiver, which are not susceptible to damage during high voltage temperature processes or require such high voltage temperature processes are located on a second die that does undergo such high voltage temperature processes.

The 10SPE Transceiver Interface standard currently under specification development by Technology Committee 14 of the Open Alliance (hereinafter the “TC14”) defines a hardware interface (specifically, a 3-pin hardware interface) for communication between a PHY transceiver and a PHY controller if a split-PHY architecture.

In 10SPE, a microcontroller (MCU) implements the PHY controller functions and an SBC implements the PHY transceiver functions. In 10SPE, the SBC's non-transceiver responsibilities include regulated power deliver (e.g., low-voltage power delivery), observability/control of high-voltage domain (e.g., handling high-voltage signals), and functional safety mechanisms for MCU to reach safe state. So, in addition to transceiver functions, the SBC implements functions of the electronic system, such as power management, watchdog circuit, monitors, general purpose input/output (GPIO), without limitation.

TC14 describes low-power (sleep-wake) behavior of the PHY transceiver for partial networking. Partial networking refers to a feature that enables selective power management and communication capabilities within a network. Partial networking allows certain network nodes or devices to enter a low-power state or sleep state while still maintaining basic communication functionality. In Ethernet networks, partial networking is utilized to optimize power consumption, particularly in automotive or industrial applications. Allowing selected devices to enter a low-power state or sleep-state may reduce overall power consumption, extend battery life, or improves energy efficiency, without limitation.

Modern MCUs typically operate at lower voltages, such as 3.3V, which makes them incompatible with direct high-voltage signals typically found in automotive, industrial, and other high-voltage applications. For instance, in automotive applications, the battery voltage (Vbat) can be nominally 12V but may vary significantly under different conditions, such as those specified by the LV 124 standard, without limitation. Similarly, other applications like fire alarm systems may operate at nominal voltages of 24V.

One or more examples relate, generally, to a system basis chip (SBC) capable of handling supply voltage signals and high-voltage signals. The SBC integrates high-voltage (HV) GPIO capabilities into the SBC, allowing it to handle high-voltage signals and interface them with low-voltage devices, such as the low-voltage MCU.

In one or more examples, the SBC is capable of level shifting high-voltage system signals to MCU-compatible levels (e.g., from 12V to 3.3V, without limitation).

Additionally or alternatively, in one or more examples, changes in high-voltage inputs may be detected and qualified by the SBC and then communicated to the MCU via interrupts. This allows the MCU to be informed of high-voltage changes without being directly exposed to high voltage.

Additionally or alternatively, in one or more examples, when the MCU writes to a register, the SBC can signalize this as a high voltage or ground (GND) output using an open-drain driver.

Additionally or alternatively, in one or more examples, the MCU can control high-voltage domain modules via GPIO outputs, enabling functionalities such as wake signaling, without limitation.

Additionally or alternatively, in one or more examples, high voltage GPIO may be utilized for wake signals (e.g., WAKEIN, without limitation) in an always-on domain (an uninterruptable voltage domain (VDDU)). This allows the SBC to wake detect and wake the system (change power state) from a low-power or sleep state based on high-voltage inputs.

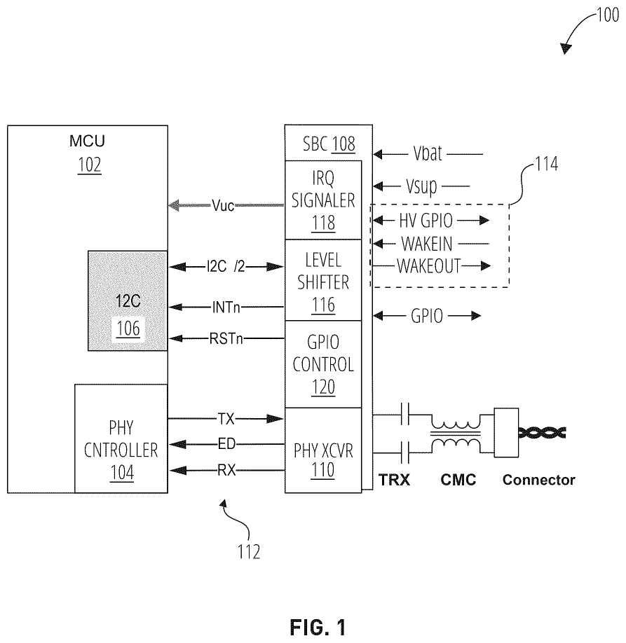

FIG. 1 is a block diagram depicting a system 100 that implements, among other things, a 10SPE PHY, in accordance with one or more examples.

The system 100 includes an MCU 102 and an SBC 108. The MCU 102 includes a PHY controller 104 and an I2C bus controller 106. The PHY controller 104 and PHY transceiver 110 form a 10SPE PHY. The PHY controller 104 and PHY transceiver 110 communicate via hardware interface 112 that includes connections for carrying signals associated with transmission signaling (TX connection), energy detection signaling (ED connection), and reception signaling (RX connection). MCU 102 and SBC 108 communicate via an I2C bus and optionally communicate via command, control, and management connections (represented in FIG. 1 by connections INTn, and RSTn, which are specific non-limiting examples of command, control, and management connections) which specifically indicate action needed from the MCU. A non-limiting example of communication via command, control, and management connections includes interrupt (IRQ) signaling.

PHY controller 104 is responsible for managing the digital aspects of the 10BASE-T1S PHY communication. It handles tasks such as encoding, decoding, and managing the link layer protocols. I2C bus controller 106 manages communication over the I2C bus, facilitating command, control, and data exchange between MCU 102 and SBC 108. In the specific example depicted by FIG. 1, optional logic that manages communication between command, control, and management connections (e.g., INTn and RSTn, without limitation) is represented by the same block that represents the I2C bus controller 106, but may be a different logical partition.

SBC 108 implements or manages functions of PHY transceiver 110, functions of the MCU 102, and its own internal functions (SBC functions, which are the non-transceiver functions). SBC 108 may optionally also implement functions of sensors (sensors not depicted, but should be considered optional). Vuc is a supply voltage managed by SBC 108 and provided to MCU 102 from SBC 108. SBC 108 may, optionally, also provide a supply voltage to other devices such as sensors (e.g., supply a Vsen, without limitation) as needed. Vsup is the supply voltage provided to SBC 108 and may be utilized to produce Vuc, e.g., directly or as a regulated version of Vsup. Vbat is a battery voltage and represents a high-voltage supply voltage (for example, an unregulated voltage source that produces higher voltage than the supply voltage VSup) provided to system 100 and SBC 108, more specifically. GPIO is a general-purpose input/output connection. Transmit/receive connections, common mode choke (CMC), and connector are physical circuits that connect SBC 108 to a physical transmission medium such as a twisted-pair, without limitation. WAKEIN is an input connection exclusively utilized to receive external power management signals (e.g., wake or sleep, without limitation) from an external source (e.g., external to system 100, without limitation). WAKEOUT is an output connection exclusively utilized to send power management signals external to system 100.

SBC 108 is capable of high-voltage I/O handling, as discussed below. In one or more examples, SBC 108 includes one or both level shifter 116 and IRQ signaler 118 to facilitate high-voltage I/O handling.

Level shifter 116 convert signals from high-voltage levels to lower, MCU-compatible voltage levels. This allows the MCU 102 to safely read high-voltage inputs of high-voltage I/O 114 without being exposed to the high voltage directly.

IRQ signaler 118 detects and qualifies changes in high-voltage inputs of high-voltage I/O 114. IRQ signaler 118 communicates the qualified signals to MCU 102 via interrupts (e.g., generates interrupts, without limitation), enabling MCU 102 to respond to high-voltage events without directly handling high-voltage signals. System 100 may include one or more interrupt and control lines that connect SBC 108 and MCU 102 to facilitate IRQ and control signaling that communicate qualified signals to the MCU 102 to notify the MCU 102 of high-voltage events.

SBC 108 may also include GPIO control 120 in an always-on domain to facilitate, in cooperation with one or more of level shifter 116 or IRQ signaler 118, power management functions such as wake detect and signaling. In one or more examples, GPIO control 120 may detect specific conditions, such as high-voltage wake signals on HV GPIO, and triggers a response by the appropriate system.

High-voltage GPIO (HV GPIO) are capable of handling higher voltage levels than the GPIO. In this context, HV GPIO handle signals represented by voltage levels of Vbat, while GPIO handle signals represented by at levels of Vsup, where Vsup is lower than Vbat.

By way of a contemplated wake process, the high-voltage GPIO pins may be configured to detect a wake signal that is represented by a change in voltage that meets specific conditions.

IRQ signaler 118 of SBC 108 qualifies the detected signal to ensure it is a valid wake event. Upon qualification, IRQ signaler 118 generates an interrupt to notify MCU 102 of the wake event. MCU 102, upon receiving the interrupt, initiates a process to transition the system from low-power or sleep state to active state.

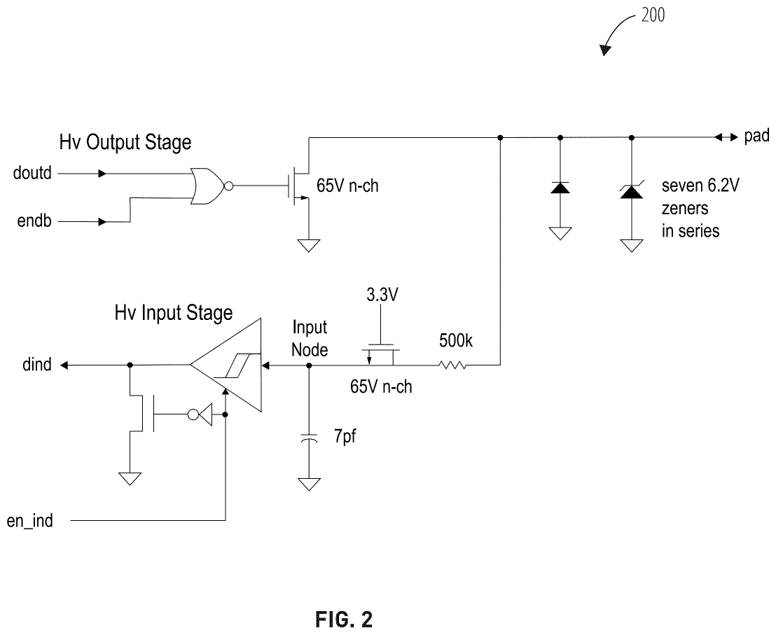

FIG. 2 a circuit diagram depicting an HV I/O 200 for an SBC, such as SBC 108, in accordance with one or more examples. HV I/O 200 may connect WAKEIN and WAKEOUT connections of an SBC (e.g., SBC 108) to a pad. The pad is for high-voltage connections. The pad operates at Vbat and the connections of the SBC operate at Vsup, where Vsup is <Vbat.

HV I/O 200 is a non-limiting example of a level shifter 116 of FIG. 1.

In one or more examples HV I/O 200 may be an internal circuit of SBC 108 that couples internal connections of SBC 108 to a connection (e.g., a pad) for connecting external to the SBC, or HV I/O 200 may be external to SBC 108, acting as an interface between connections of the SBC for connecting to external sources and such external sources.

A high voltage input stage includes a comparator with hysteresis (here, a Schmitt trigger). An output of the comparator is coupled to an internal wake signaling connection dind, of the SBC. This output is switchably coupled to ground by a transistor switch. This output of the comparator may be connected in series or parallel to dind depending on the state of the transistor switch. When the switch is ON, the output of the comparator is coupled in parallel to dind, when the switch is OFF, the output of the comparator is coupled in series with dind. The switch's gate and the comparator's reference input are coupled to receive the signal en-ind.

The input of the comparator is coupled, in parallel to an input node, which is also coupled to ground via a capacitor. The input node is switchably coupled to a high-value resistor (here, a 500K ohms resistor) via another transistor switch. The gate of this transistor switch is coupled to Vsup (here, 3.3 v). This transistor is n-channel MOSFET, coupled in series with the high-value resistor. The other end of the high-value resistor is coupled to a node that is in parallel with multiple series-coupled Zener diodes and the pad.

In one or more examples, wake events may be indicated as specific voltage changes at the pad. A signal detector (not depicted by FIG. 2) may set an internal bit (e.g., a flag, without limitation) in response to detection of a valid voltage change at dind. The valid voltage change of dind may be utilized to infer a valid voltage change at the pad. A valid voltage change at the pad indicates a wake signal at the pad. When a voltage potential of Vbat is at the pad, that causes Vbat (3.3V) to appear at the input of the comparator. When a ground voltage potential is at the pad, that causes ground voltage to appear at the input of the comparator.

The portion of the circuit of HV I/O 200 above the portion of the circuit that includes the high-voltage input stage is the high-voltage output stage. Doutd and Endb are internal signals utilized to control the output state of the pad. Connections to Doutd and Endb are connected to inputs of a NOR gate. When Doutd and Endb are set to 0, the gate output (GATE_out) is set to 1. When either or both Doutd and Endb are set to 1, the gate output (GATE_out) is set to 0. In a case where the transistor switch is an N-channel MOSFET, when doutd and endb are a 0 (ground)the transistor switch is ON and allows current to flow and so the pad is at ground, and when one or both of doutd and endb are both at logic level 1, the transistor switch is OFF and does not allow current to flow and so the pad is at VBAT.

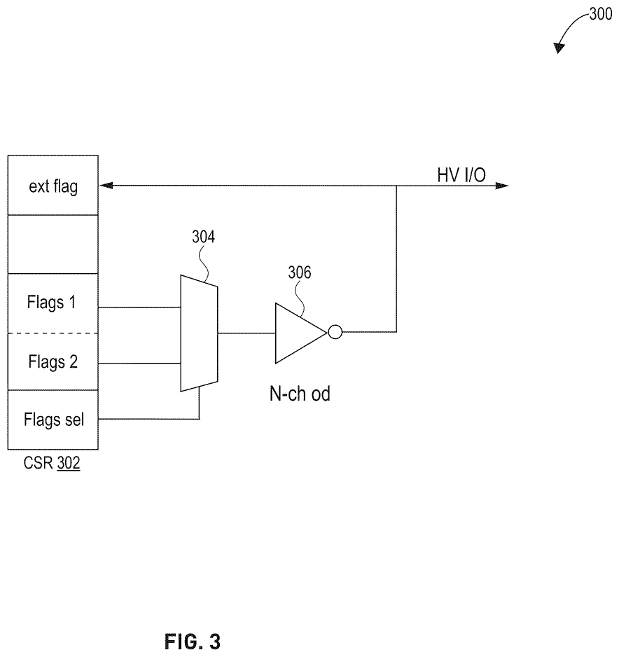

FIG. 3 is a schematic diagram of a system 300 to drive a high-voltage GPIO of an SBC, in accordance with one or more examples. System 300 includes CSR 302, MUX 304 and inverter 306.

CSR 302 is a command status register that at least includes the bits EXT Flag, Flags 1, Flags 2, and Flag Select. Flags 1, Flags 2, and Flag Select are available to utilize as needed based on specific operating conditions.

MUX 304 provides a MUX selection between Flag 1 and Flag 2 at least partially based on flag select. The output of MUX 304 is coupled to a high-voltage I/O by inverter 306. EXT flag is a bit that can be set by the GPIO (e.g., an external wake signal, without limitation), as a non-limiting example, via HV I/O 200.

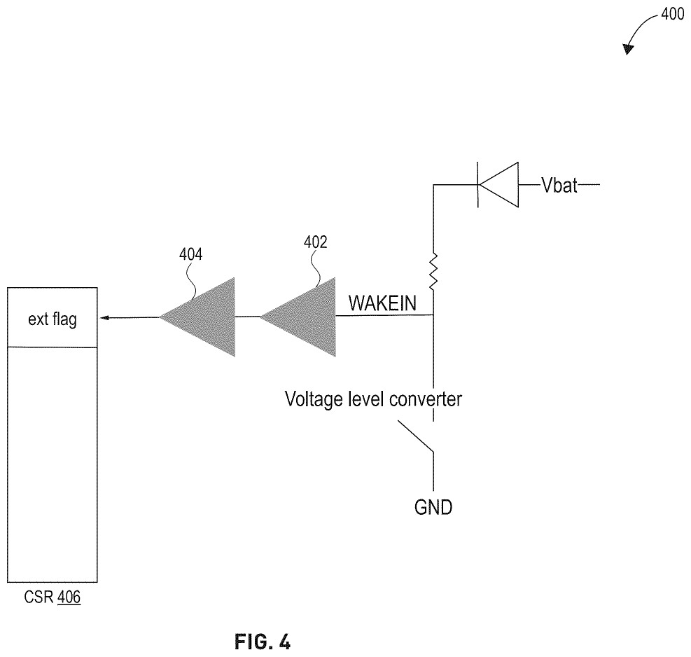

FIG. 4 is a schematic diagram depicting system 400 to generate an internal signal via a high-voltage IO of FIG. 2, in accordance with one or more examples. System 400 includes high-voltage input/output 402, signal detector 404, and CSR 406.

System 300 receives an input signal (a voltage signal) having a voltage range of Vbat to ground (i.e., in the high voltage domain). High-voltage input/output 402 (which may be an HV I/O 200 of FIG. 2) converts that voltage signal to a signal at an interval voltage level, and the converted signal is fed to signal detector 404, which determines portions of the signal present at the pad that were a valid input signal based on the output of high-voltage input/output 402, and indicates the valid signal at its output. EXT_Flag of the CSR is set based on the output of signal detector 404.

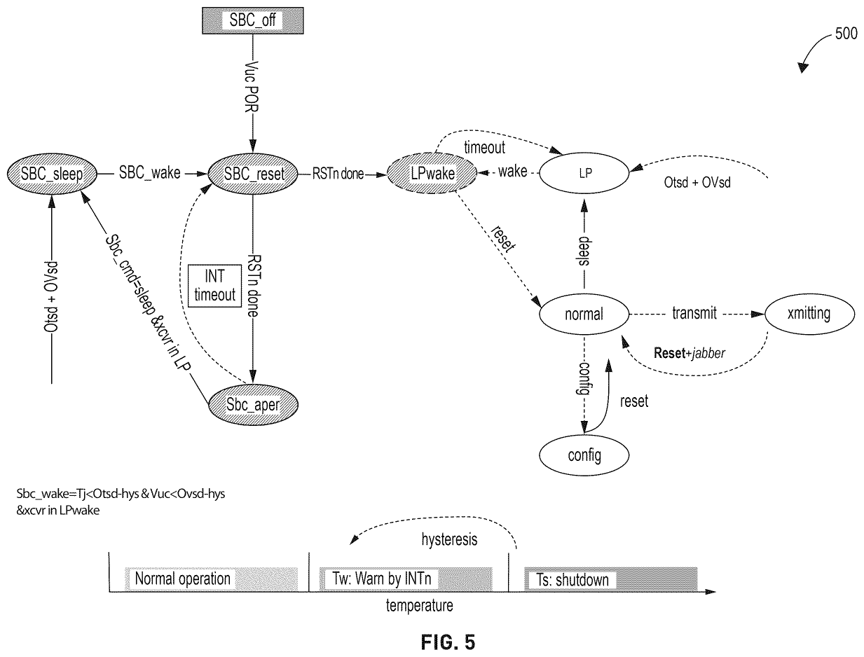

FIG. 5 is a state diagram depicting behavior of an SBC managing a high voltage GPIO, in accordance with one or more examples. The vertices represent states (specifically, modes of operation): SBC_sleep, SBC_reset, LPwake, LP, SBC_operative, normal, config. Directed edges between vertices represent transitions from one state to another state. Conditions or events that trigger transitions indicated by the directed edges are also depicted.

The SBC off state (SBC_off) is an initial state where the SBC is completely powered off. The SBC can transition from SBC_off to SBC_reset in response to the Vuc Power-On Reset (POR).

The SBC reset state (SBC_reset) is a state where the SBC initializes its components and prepares for operation. The SBC can transition from SBC off to SBC operational state (SBC_oper) in response to a reset signal (RSTn) being done, indicating that the reset process is complete.

The SBC operational state (SBC_oper) is where the SBC is fully functional and can perform its tasks. The SBC can transition from SBC operational state (SBC_oper) to SBC sleep state (SBC_sleep) in response to an SBC command to sleep and the PHY transceiver being in Low Power (LP) mode. The SBC can transition from SB operational state (SBC_oper) to low power (LP) wake state in response to an interrupt timeout. The SBC can transition from SB operational state (SBC_oper) to SBC_reset in response to a reset signal (RSTn) indicating done.

The SBC sleep state (SBC_sleep) is a low-power sleep state where the SBC minimizes its power consumption. The SBC can transition from SBC sleep state (SBC_sleep) to SBC wake state (SBC_wake) in response to an over-temperature shutdown (OTSD) and over-voltage shutdown (OVSD). The SBC can transition from SBC sleep state to an SBC operational state (SBC_oper) in response to an SBC command to wake and the PHY transceiver being in LP mode.

The SBC wake state (SBC_wake) is a transitional state where the SBC is transitioning from SBC sleep state to SBC operational state.

The low power wake state (LPwake) is a state indicating that the PHY transceiver is waking up from a low-power state. The LPwake state is triggered by a wake signal.

The low power state (LP) is a state indicating a low-power state of the PHY transceiver where it consumes minimal power. The LP state is triggered by a wake signal.

The normal state (normal) is a normal operational state for the PHY transceiver where it performs its standard functions. The PHY transceiver can transition from the normal state to the transmit state, configuration state (config), or low power state. The transition to the transmit state is triggered by the need to send data. The transition to the configuration state (config) is triggered by a configuration command. A transition to the low power state (LP) is triggered by sleep commands.

The transmit state (transmit) is the state where the PHY transceiver is ready to receive and transmit data. The PHY transceiver may transmit from the transmit state to a transmitting state (xmiting), which is triggered by transmission starting.

The transmitting state (xmiting) is a state indicating that the PHY transceiver is in the process of transmitting data. The PHY transceiver can transition from transmitting state to normal state, triggered by the completion of data transmission.

The configuration state (config) is a state where the PHY transceiver is being configured. The PHY transceiver can transition from configuration state to normal state, triggered by the completion of configuration.

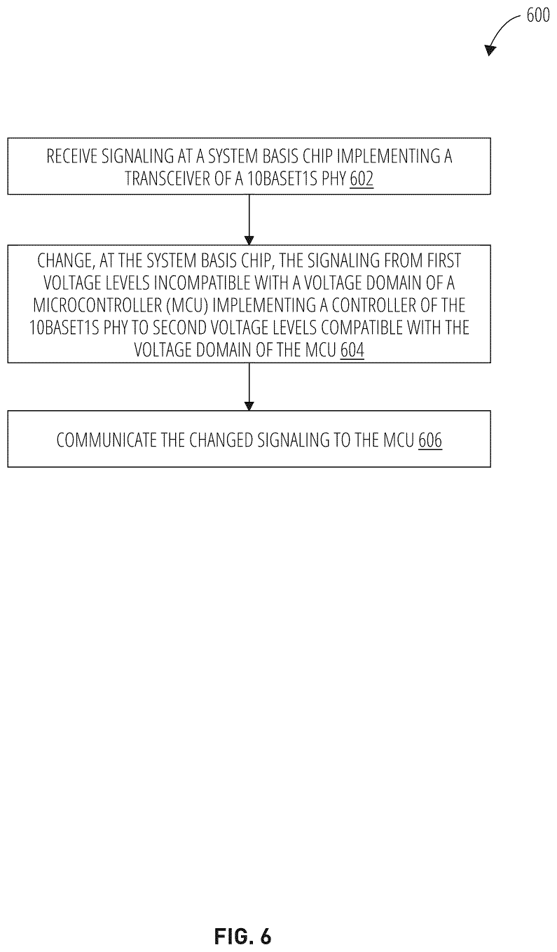

FIG. 6 is a flow diagram depicting a process 600 to handle high-voltage signals and interface them with a low-voltage MCU, in accordance with one or more examples.

Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence.

According to some examples, the method includes receiving signaling at a system basis chip implementing a transceiver of a 10SPE PHY at block 602.

According to some examples, the method includes changing, at the system basis chip, the signaling from first voltage levels incompatible with a voltage domain of a microcontroller (MCU) implementing a controller of the 10SPE PHY to second voltage levels compatible with the voltage domain of the MCU at block 604.

According to some examples, the method includes communicating the changed signaling to the MCU at block 606.

It will be appreciated by those of ordinary skill in the art that functional elements of examples disclosed herein (e.g., functions, operations, acts, processes, or methods) may be implemented in any suitable hardware, software, firmware, or combinations thereof.

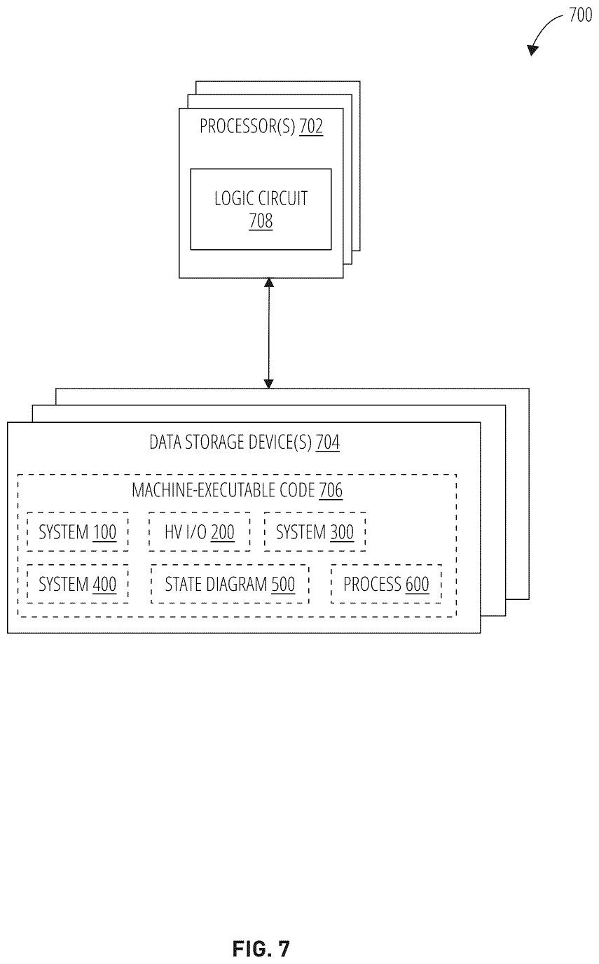

FIG. 7 illustrates non-limiting examples of implementations of functional elements disclosed herein. In some examples, some or all portions of the functional elements disclosed herein may be performed by hardware capable of carrying out the functional elements.

FIG. 7 is a block diagram of a circuitry 700 that, in some examples, may be used to implement various functions, operations, acts, processes, or methods disclosed herein.

The circuitry 700 includes one or more processors 702 (sometimes referred to herein as “processors 702”) operably coupled to one or more data storage devices 704 (sometimes referred to herein as “storage 704”). The storage 704 includes machine executable code 706 stored thereon and the processors 702 include logic circuit 708. The machine executable code 706 information describes functional elements that may be implemented by (e.g., performed by) the logic circuit 708. The logic circuit 708 is adapted to implement (e.g., perform) the functional elements described by the machine executable code 706. The circuitry 700, when executing the functional elements described by the machine executable code 706, should be considered as special purpose hardware for carrying out functional elements disclosed herein. In some examples the processors 702 may perform the functional elements described by the machine executable code 706 sequentially, concurrently (e.g., on one or more different hardware platforms), or in one or more parallel process streams.

When implemented by logic circuit 708 of the processors 702, the machine executable code 706 adapts the processors 702 to perform operations of examples disclosed herein. By way of non-limiting example, the machine executable code 706 may adapt the processors 702 to perform some or a totality of operations to facilitate high-voltage I/O handling discussed herein, such as high voltage wake signaling input/output for a 10BASE-T1S system basis chip, without limitation. By way of non-limiting example, processors machine executable code 706 may adapt the processors 702 to perform some or a totality of operations of state diagram 500 or process 600.

Also, by way of non-limiting example, the machine executable code 706 may adapt the processors 702 to perform some or a totality of features, functions, or operations disclosed herein for one or more of system 100, HV I/O 200, system 300, system 400, or a finite state machine (FSM) that implements state diagram 500. More specifically, features, functions, or operations disclosed herein for coordinate power state changes.

The processors 702 may include a general purpose processor, a special purpose processor, a central processing unit (CPU), a microcontroller, a programmable logic controller (PLC), a digital signal processor (DSP), an application-specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine executable code 706 (e.g., software code, firmware code, hardware descriptions) related to examples of the present disclosure. It is noted that a general-purpose processor (may also be referred to herein as a host processor or simply a host) may be a microprocessor, but in the alternative, the processors 702 may include any conventional processor, controller, microcontroller, or state machine. The processors 702 may also be implemented as a combination of computing devices, such as a combination of a DSP and a microprocessor, a plurality of microprocessors, one or more microprocessors in conjunction with a DSP core, or any other such configuration.

In some examples the storage 704 includes volatile data storage (e.g., random-access memory (RAM)), non-volatile data storage (e.g., Flash memory, a hard disc drive, a solid-state drive, erasable programmable read-only memory (EPROM), without limitation). In some examples the processors 702 and the storage 704 may be implemented into a single device (e.g., a semiconductor device product, a system on chip (SOC), without limitation). In some examples the processors 702 and the storage 704 may be implemented into separate devices.

In some examples the machine executable code 706 may include computer-readable instructions (e.g., software code, firmware code). By way of non-limiting example, the computer-readable instructions may be stored by the storage 704, accessed directly by the processors 702, and executed by the processors 702 using at least the logic circuit 708. Also, by way of non-limiting example, the computer-readable instructions may be stored on the storage 704, transferred to a memory device (not shown) for execution, and executed by the processors 702 using at least the logic circuit 708. Accordingly, in some examples the logic circuit 708 includes electrically configurable logic circuit 708.

In some examples the machine executable code 706 may describe hardware (e.g., circuitry) to be implemented in the logic circuit 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine executable code 706 may include an HDL, an RTL, a GL description, a mask level description, other hardware description, or any combination thereof.

In examples where the machine executable code 706 includes a hardware description (at any level of abstraction), a system (not shown, but including the storage 704) implements the hardware description described by the machine executable code 706. By way of non-limiting example, the processors 702 may include a programmable logic device (e.g., an FPGA or a PLC) and the logic circuit 708 may be electrically controlled to implement circuitry corresponding to the hardware description into the logic circuit 708. Also by way of non-limiting example, the logic circuit 708 may include hard-wired logic manufactured by a manufacturing system (not shown, but including the storage 704) according to the hardware description of the machine executable code 706.

Regardless of whether the machine executable code 706 includes computer-readable instructions or a hardware description, the logic circuit 708 is adapted to perform the functional elements described by the machine executable code 706 when implementing the functional elements of the machine executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: An apparatus, comprising: a pad associated with high-voltage signaling, the high-voltage signaling represented by voltage changes between first voltage levels; a system basis chip, comprising: a circuit to change a voltage signal between first voltage levels and second, corresponding voltage levels, the second voltage levels lower than the first voltage levels, the first voltage levels utilized at the pad and the second voltage levels utilized by the system basis chip; and a signal detector to detect a valid voltage change at the pad responsive to the changed voltage signal.

Example 2: The apparatus according to Example 1, wherein: a voltage range of the first voltage levels is defined between ground voltage potential and a first voltage level; and a voltage range of the second voltage levels is defined between ground voltage potential and a second voltage level lower than a battery voltage.

Example 3: The apparatus according to any of Examples 1 and 2, comprising: a register of a system basis chip (SBC) to store an output of the signal detector; and an input path of the circuit, the input path from the pad to the register, wherein the pad is supplied by a first supply voltage that provides the first voltage levels, and the input path of the circuit is supplied by a second supply voltage that provides the second voltage levels.

Example 4: The apparatus according to any of Examples 1 through 3, wherein the input path includes a high-value series resistor to limit current flow through the circuit when a high voltage is applied to the pad.

Example 5: The apparatus according to any of Examples 1 through 4, comprising: an interrupt signaler to communicate an event at least partially based information stored at the register of the SBC.

Example 6: The apparatus according to any of Examples 1 through 5, wherein the system basis chip implements a 10SPE PHY transceiver.

Example 7: The apparatus according to any of Examples 1 through 6, comprising: a register to store an output signal; and an output path of the circuit, the output path from the register to the pad, wherein the pad is supplied by a first supply voltage that provides the first voltage levels, and the output path of the circuit is supplied by a second supply voltage that provides the second voltage levels.

Example 8: An apparatus, comprising: a microcontroller implementing a controller of a 10SPE physical layer (PHY); and a system basis chip implementing a transceiver of the 10SPE PHY, wherein the system basis chip to receive and handle high-voltage, external signals and interface the high-voltage, external signals with a low-voltage domain of a microcontroller (MCU).

Example 9: The apparatus according to Example 8, wherein the high-voltage, external signals include external wake signaling and the system basis chip to: generate internal wake signaling representative of the external wake signaling, a voltage range of the high-voltage, external signals defined between a ground voltage level and a first voltage level, and a voltage range of the internal wake signaling defined between a ground voltage and a second voltage level lower than the first voltage level.

Example 10: The apparatus according to any of Examples 8 and 9, wherein the system basis chip to communicate a wake event to the MCU at least partially based on the internal wake signaling.

Example 11: The apparatus according to any of Examples 8 through 10, wherein the system basis chip to provide the internal wake signaling to the MCU.

Example 12: A method, comprising: receiving signaling at a system basis chip implementing a transceiver of a 10SPE PHY; changing, at the system basis chip, the signaling from first voltage levels incompatible with a voltage domain of a microcontroller (MCU) implementing a controller of the 10SPE PHY to second voltage levels compatible with the voltage domain of the MCU; and communicating the changed signaling to the MCU.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the present disclosure as hereinafter claimed along with their legal equivalents. In addition, features from one example may be combined with features of another example while still being encompassed within the scope of the present disclosure.

1. An apparatus, comprising:
a pad associated with high-voltage signaling, the high-voltage signaling represented by voltage changes between first voltage levels;
a system basis chip, comprising:
a circuit to change a voltage signal between first voltage levels and second, corresponding voltage levels, the second voltage levels lower than the first voltage levels, the first voltage levels utilized at the pad and the second voltage levels utilized by the system basis chip; and
a signal detector to detect a valid voltage change at the pad responsive to the changed voltage signal.

2. The apparatus of claim 1, wherein:
a voltage range of the first voltage levels is defined between ground voltage potential and a first voltage level; and
a voltage range of the second voltage levels is defined between ground voltage potential and a second voltage level lower than a battery voltage.

3. The apparatus of claim 2, comprising:
a register of a system basis chip (SBC) to store an output of the signal detector; and
an input path of the circuit, the input path from the pad to the register,
wherein the pad is supplied by a first supply voltage that provides the first voltage levels, and the input path of the circuit is supplied by a second supply voltage that provides the second voltage levels.

4. The apparatus of claim 3, wherein the input path includes a high-value series resistor to limit current flow through the circuit when a high voltage is applied to the pad.

5. The apparatus of claim 3, comprising:
an interrupt signaler to communicate an event at least partially based information stored at the register of the SBC.

6. The apparatus of claim 1, wherein the system basis chip implements a 10SPE PHY transceiver.

7. The apparatus of claim 1, comprising:
a register to store an output signal; and
an output path of the circuit, the output path from the register to the pad,
wherein the pad is supplied by a first supply voltage that provides the first voltage levels, and the output path of the circuit is supplied by a second supply voltage that provides the second voltage levels.

8. An apparatus, comprising:
a microcontroller implementing a controller of a 10SPE physical layer (PHY); and
a system basis chip implementing a transceiver of the 10SPE PHY,
wherein the system basis chip to receive and handle high-voltage, external signals and interface the high-voltage, external signals with a low-voltage domain of a microcontroller (MCU).

9. The apparatus of claim 8, wherein the high-voltage, external signals include external wake signaling and the system basis chip to:
generate internal wake signaling representative of the external wake signaling, a voltage range of the high-voltage, external signals defined between a ground voltage level and a first voltage level, and a voltage range of the internal wake signaling defined between a ground voltage and a second voltage level lower than the first voltage level.

10. The apparatus of claim 9, wherein the system basis chip to communicate a wake event to the MCU at least partially based on the internal wake signaling.

11. The apparatus of claim 9, wherein the system basis chip to provide the internal wake signaling to the MCU.

12. A method, comprising:
receiving signaling at a system basis chip implementing a transceiver of a 10SPE PHY;
changing, at the system basis chip, the signaling from first voltage levels incompatible with a voltage domain of a microcontroller (MCU) implementing a controller of the 10SPE PHY to second voltage levels compatible with the voltage domain of the MCU; and
communicating the changed signaling to the MCU.
